(19) United States
(12) Patent Application Publication
(10) Pub. No.: US 2013/0179241 A1
(43) Pub. Date: Jul. 11, 2013

(54) UNIVERSAL LOYALTY PROGRAM AND SYSTEM, WHICH CAN INCLUDE ASPECTS IN FOOD AND MEDICINE RECALL, ANTI-COUNTERFEITING, ANTI-IDENTITY THEFT, ANTI-CREDIT CARD FRAUD AND MORE

(71) Applicant: Jiwen Liu, Foster City, CA (US)

(72) Inventor: Jiwen Liu, Foster City, CA (US)

(21) Appl. No.: 13/733,665

(22) Filed: Jan. 3, 2013

Related U.S. Application Data
(60) Provisional application No. 61/583,274, filed on Jan. 5, 2012.
(60) Provisional application No. 61/616,174, filed on Mar. 27, 2012.
(60) Provisional application No. 61/702,496, filed on Sep. 18, 2012.

(51) Int. Cl. G06Q 30/02

(52) U.S. Cl. CPC G06Q 30/0229
USPC 705/14.3

(57) ABSTRACT

The present invention includes providing a universal loyalty program, such as, for example, a loyalty program that includes participation of multiple separately-owned large retail companies as well as users who are customers of each of the companies. Wide and large scale participation and data sharing, among companies or other entities as well as users, may be encouraged, incentivized, obtained and rewarded, such as through programs provided by the universal loyalty program. Such programs may include, among others, a food recall related program, a medicine recall related program, an anti-counterfeiting program, a credit card fraud prevention program, and an anti-identity theft program. Moreover, the universal loyalty program, as well as the other programs, may themselves benefit and be strengthened by the wide and large scale participation, including the resulting wide and large scale data sharing, collection, mining and uses afforded in part thereby.

### PRIORITY APPLICATIONS

This application claims priority to U.S. provisional application No. 61/583,274 filed on Jan. 5, 2012, U.S. provisional application No. 61/616,174 filed on Mar. 27, 2012, and U.S. provisional application No. 61/702,496 filed on Sep. 18, 2012.

### BACKGROUND

Various types of customer loyalty programs are known, such as store shopping cards, airline frequent flyer programs, etc. However, there is a need for improvement in the general area of loyalty programs, as well as, for example, other programs that may utilize collected data, such as product or customer data.

### SUMMARY

Some embodiments of the invention provide systems and methods that include providing a universal loyalty program, such as, for example, a loyalty program that includes participation of multiple separately-owned large retail companies as well as users who are customers of each of the companies. Wide and large scale participation and data sharing, among companies or other entities as well as users, may be encouraged, incentivized, obtained and rewarded, such as through programs provided by the universal loyalty program. Such programs may include, among others, a food recall related program, a medicine recall related program, an anti-counterfeiting program, a credit card fraud prevention program, and an anti-identity theft program. Moreover, the universal loyalty program, as well as the other programs, may themselves benefit and be strengthened by the wide and large scale participation, including the resulting wide and large scale data sharing, collection, mining and uses afforded in part thereby.

### BRIEF DESCRIPTION OF THE DRAWINGS

FIG. 1A is a distributed computer system according to one embodiment of the invention;

FIG. 1B is a distributed computer system according to one embodiment of the invention;

FIG. 2 is a block diagram illustrating one embodiment of the invention;

FIG. 3 is a block diagram illustrating one embodiment of the invention;

FIG. 4 is a block diagram illustrating one embodiment of the invention;

FIG. 5 is a block diagram illustrating one embodiment of the invention;

FIG. 6 is a block diagram illustrating one embodiment of the invention;

FIG. 7 is a flow diagram illustrating a method according to one embodiment of the invention;

FIG. 8 is a flow diagram illustrating a method according to one embodiment of the invention;

FIG. 9 is a flow diagram illustrating a method according to one embodiment of the invention;

FIG. 10 is a flow diagram illustrating a method according to one embodiment of the invention; and

FIG. 11 is a flow diagram illustrating a method according to one embodiment of the invention.

While the invention is described with reference to the above drawings, the drawings are intended to be illustrative, and the invention contemplates other embodiments within the spirit of the invention.

### DETAILED DESCRIPTION

Herein, the term “ARTAS” is intended to include, broadly and generally, what is described herein as an “Authentication, Recall, Targeted Advertising, and more System”. However, the term ARTAS can further include any system, method, or apparatus incorporating embodiments of the invention, whether or not such embodiments include authentication, recall, or targeted advertising. For example, ARTAS, as used herein, can include a universal loyalty program or system, or any other program or system according to embodiments of the invention.

Herein the term “loyalty program” is intended to include, broadly, generally, and without exclusion, programs (not necessarily a computer program), systems, arrangements, relationships, associations, etc. in which users or customers are associated in some way with one or more companies, brands, other business entities, etc. Generally, although not exclusively, for example, in a loyalty program, customers may be provided with some benefit from the company or companies, and the company or companies have some desire or expectation that customer participation in the loyalty program may in some way or ways facilitate, increase or enhance the relationship between the customer and the company or companies. For example, in some loyalty programs, points or credits may be awarded to participating customers, and may be linked to customer purchases, etc. In some loyalty programs, loyalty cards may be utilized. Furthermore, customers may receive coupons, discounts, etc., through loyalty programs. The term “loyalty” in “loyalty program” is not intended to limit the term to programs that actually involve or require loyalty. Furthermore, many other forms of loyalty programs are contemplated herein, including, without exclusion, various such programs as described herein.

Furthermore, the term “universal loyalty program”, as the term is used herein, is intended to include, broadly, generally and without exclusion, any loyalty program that includes or comprehends multiple company participants.

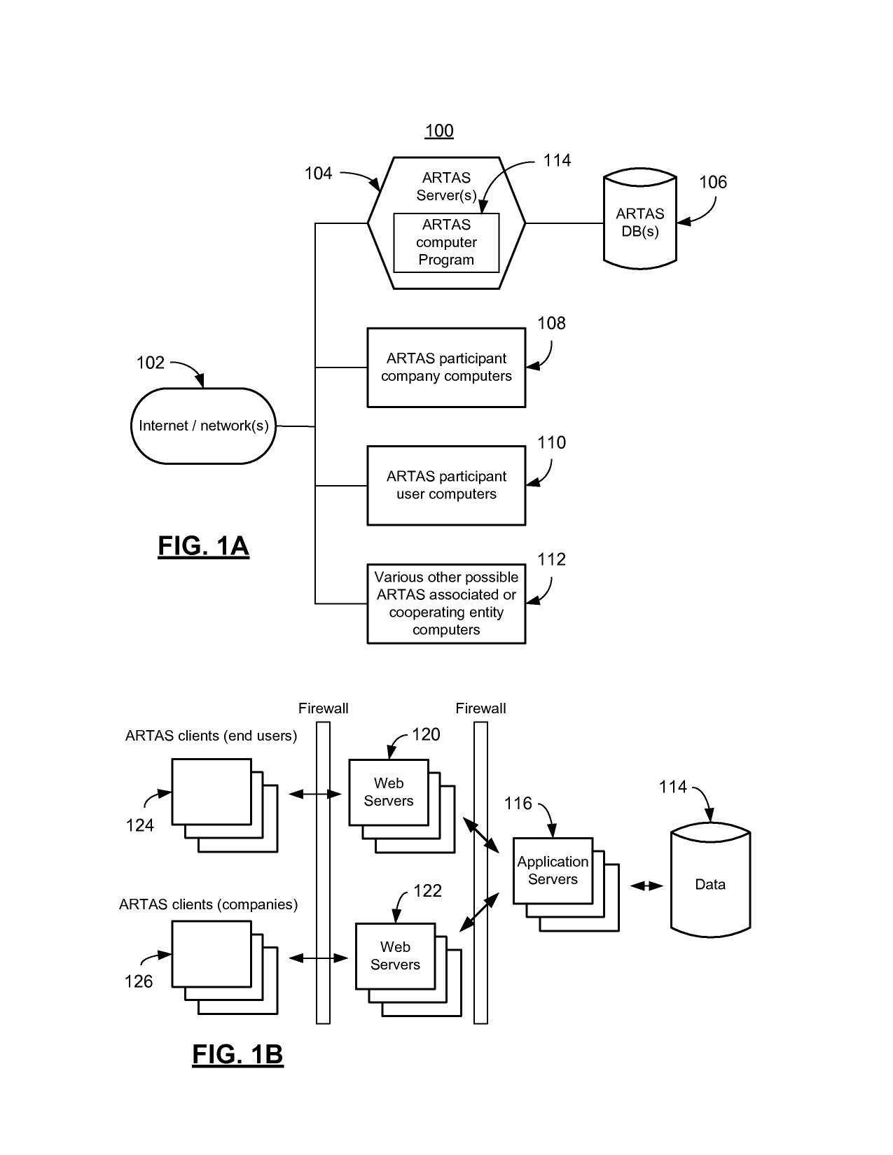

FIG. 1A is a distributed computer system 100 according to one embodiment of the invention. The system 100 includes one or more networks 102, which may include the Internet, one or more wireless networks, WANs, LANs, telephone, cell phone, or other data networks, etc. Computers, as depicted or described herein, may be or include, among other things, wireless, portable, or handheld devices such as cell phones, smart phone, PDAs, tablets, etc.

The system 100 includes, coupled or coupleable to the network(s) 102, one or more ARTAS server computers 104, one or more ARTAS participant company computers 108, one or more ARTAS participant user computers 110, and may or may not include various other ARTAS associated or cooperating entity computers 112.

Each of the computers may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, data analysis, data mining, machine learning, and advertising, such as graphical or banner advertising as well as keyword searching and advertising in a sponsored search context. Many types of advertisements are contemplated, including textual advertisements, rich advertisements, video advertisements, coupon-related advertisements, group-related advertisements, social networking-related advertisements, etc.

As depicted, the ARTAS server computer(s) 104 includes one or more CPUs and a data storage device an ARTAS computer Program 114.

The Program 114 is intended to broadly include all programming, applications, algorithms, software, engines, modules, functions, models, and other tools necessary to implement or facilitate methods and systems according to embodiments of the invention. The elements of the Program 114 may exist on a single server computer or be distributed among multiple computers or devices.

Furthermore, an ARTAS database(s) 106 is conceptually depicted, which may or may not be part of the ARTAS server computer(s), and may include distributed elements or components which may be spread across various computers, systems, or data storage devices, etc.

In some embodiments, ARTAS server computers may include various types of server computers, including Web servers, application servers, etc. Furthermore, one or more firewalls may be utilized in various ways.

FIG. 1B is a distributed computer system according to one embodiment of the invention. As depicted, ARTAS application servers 116, are coupled to ARTAS data 114, which may include one or more ARTAS databases. The ARTAS application servers 116 are also coupled to ARTAS Web servers 120, 122 through one or more firewalls. The ARTAS web servers 120 are coupled, through one or more firewalls, to ARTAS client end users 124, who may be using, for example, desktop computers, wired or wireless computers, tablets, smart phones, PDAs, etc. Furthermore, ARTAS Web servers 122 are coupled, through one or more firewalls, to ARTAS client companies, via browsers, Web services clients, etc., and by any of various computers or devices.

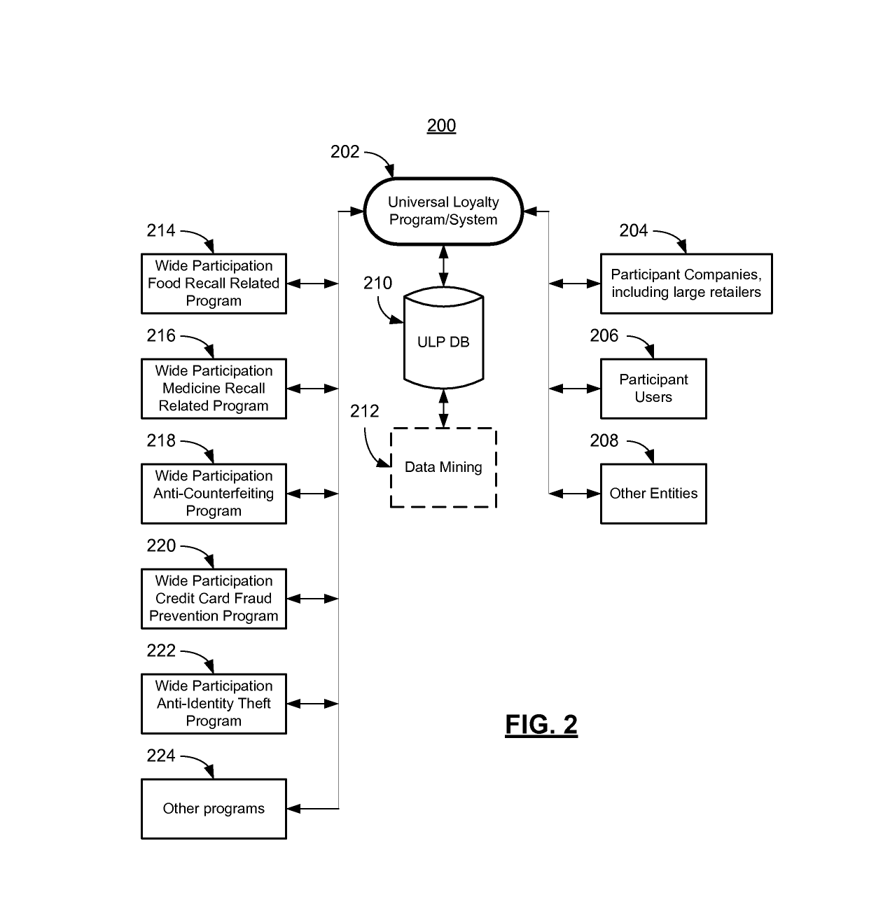

FIG. 2 is a block diagram 200 illustrating one embodiment of the invention. A universal loyalty program/system is depicted 202, including or coupled or coupleable to a universal loyalty program database 210. Furthermore, data mining is conceptually depicted 212, using data from the database 210, and which is intended to broadly include data usage, data analysis, data finding, data selection, data narrowing or determination, data modeling, data structures, construction or creation of other data, etc.

The universal loyalty program/system is associated with participant companies, including large retailers, 204, participant users 206, and may also be associated with other entities 208.

As conceptually depicted, the universal loyalty program/system 202, using data from the database 210, may be associated with, include, facilitate, or implement one or more other programs, such as wide participation programs. Such programs may include, for example, a food, medicine, and/or other product recall related programs 214, 216, an anti-counterfeiting (including product or service related fraud, etc.) program 218, a credit card (including payment cards, related cards or items, etc.) fraud prevention program 220, an anti-identity theft program 222, and/or other programs 224. It is to be understood that some embodiments of the invention do not include a universal loyalty program, but may include one or more other programs.

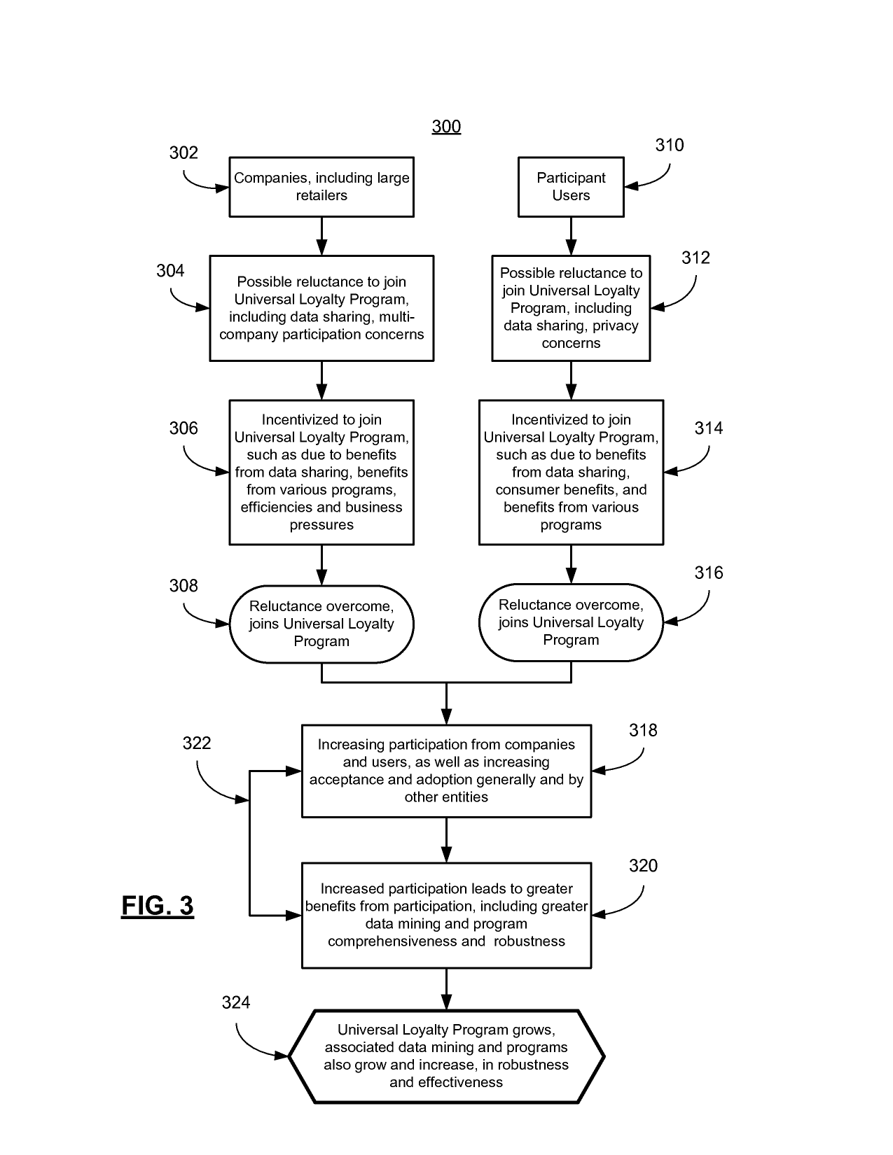

FIG. 3 is a block diagram 300 illustrating one embodiment of the invention. Companies, including large retailers, are depicted 302. As represented by block 304, the companies may have reluctance regarding joining the universal loyalty program, including data sharing, multi-company participation concerns. As represented by block 306, however, the companies are incentivized to join the universal loyalty program, such as due to benefits from or associated with, for example, data sharing, benefits from various programs, efficiencies and business pressures. Block 308 represents a company, or companies, overcoming any reluctance, and joining the universal loyalty program.

Furthermore, participant users are depicted 310. As represented by block 312, the users may have reluctance to join as well, such as by having concerns relating to data sharing, privacy and personal information security concerns, etc. As represented by block 314, however, the users are incentivized to join universal loyalty program, such as, for example, due to benefits from data sharing, consumer benefits, and benefits from various programs. As represented by block 316, the user or users' reluctance is overcome, and the user or users join the universal loyalty program.

Block 318 represents increasing participation from companies and users, as well as increasing acceptance and adoption generally and by other entities. Block 320 represents increased participation leading to greater benefits from participation, including greater data mining and program comprehensiveness and robustness. As represented by double-headed arrow 322, this can create a positive iterative feedback loop or situation.

As represented by block 324, the universal loyalty program grows, and associated data mining and programs also grow and increase, in robustness and effectiveness.

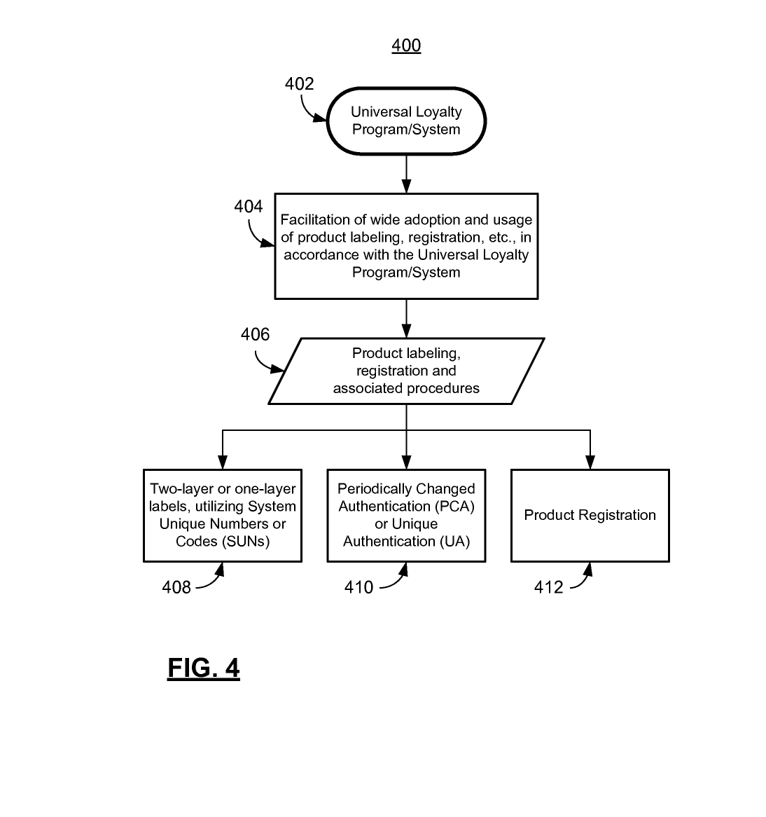

FIG. 4 is a block diagram 400 illustrating one embodiment of the invention. Block 402 represents a universal loyalty program/system. Block 404 represents facilitation of wide adoption and usage of product labeling, registration, etc., in accordance with the universal loyalty program/system. Block 406 represents Product labeling, registration and associated procedures, in association with the universal loyalty program.

Block 408 represents some labeling possibilities, which may include two-layer or one-layer labeling including or utilizing system unique numbers or codes (SUNs).

Block 410 represents some authentication elements that may be utilized in connection with labeling and system unique numbers or codes (SUNs), which may include one or both of Periodically Changed Authentication (PCA) or Unique Authentication (UA).

Block 412 represents product registration in connection with the universal loyalty program/system, which may, for example, by done manually or automatically, may be done at a point of sale or later, etc.

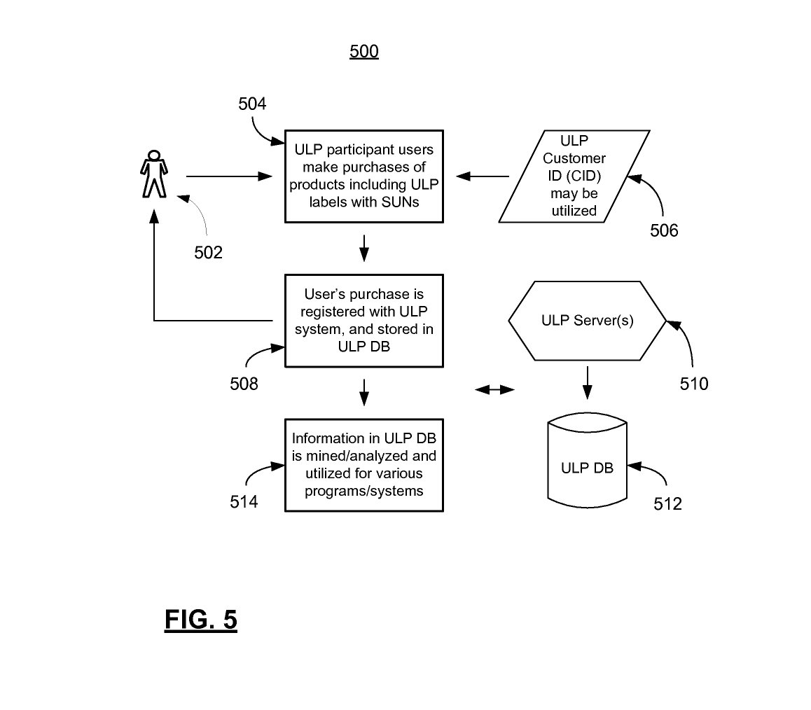

FIG. 5 is a block diagram 500 illustrating one embodiment of the invention. A participant user or users 502 is depicted.

The user or users 502 make purchases of products including universal loyalty program/system related labels with system unique numbers (SUNs) 504. In some embodiments, a universal customer ID (CID), embodiments of which are further described herein, may be utilized 506, such as at the point of purchase.

The user or users purchase(s) is registered with the universal loyalty program/system and stored in universal loyalty program/system database 508, such as through use of one or more universal loyalty program/system server computers 510 and database(s) 512.

As depicted by block 514, the Information in the universal loyalty program database may be mined/analyzed and utilized for various programs/systems.

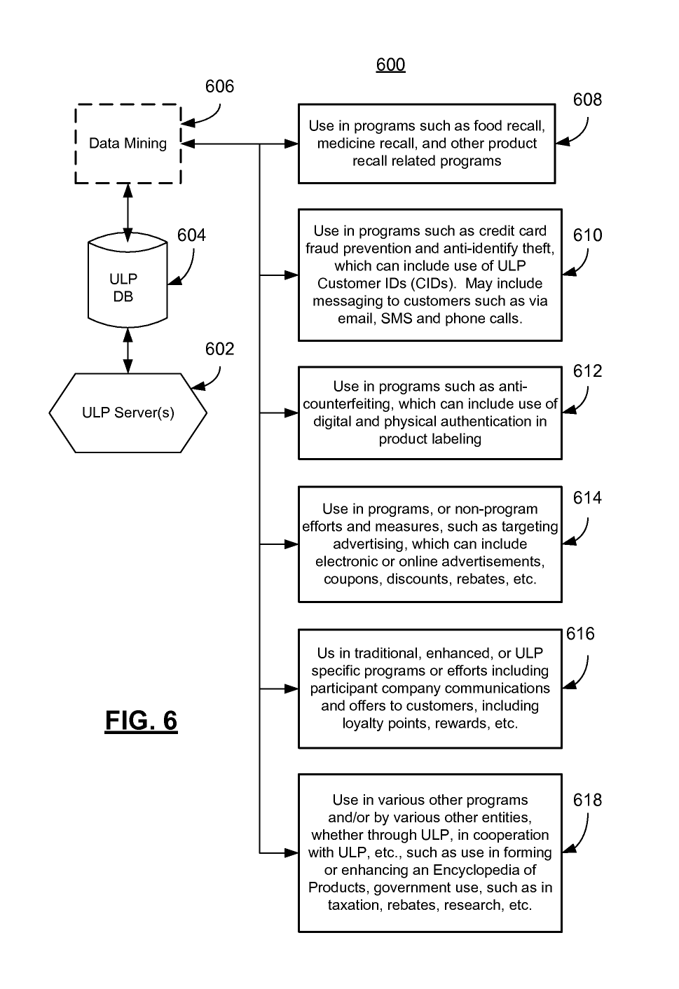

FIG. 6 is a block diagram 600 illustrating one embodiment of the invention. As depicted, a universal loyalty program server computer(s) 602 is utilized, along with a universal loyalty program database 604 and data usage or data mining 606 that utilizes data in the database 604.

Blocks 608-618 represent various possible uses of the data or results of the data usage or mining.

Specifically, block 608 represents use in programs such as food recall, medicine recall, and other product recall related programs.

Block 610 represents use in programs such as credit card fraud prevention and anti-identify theft, which can include use of customer IDs (CIDs), and may include messaging to customers such as, for example, via email, SMS and/or phone calls.

Block 612 represents use in programs such as anti-counterfeiting, which can include use of digital and physical authentication in product labeling.

Block 614 represents use in programs, efforts and/or measures, such as targeting advertising, which can include electronic or online advertisements, coupons, discounts, rebates, etc.

Block 616 represents use in traditional, enhanced, or universal loyalty program specific programs or efforts including participant company communications and/or offers to customers, including loyalty points, rewards, various benefits, etc.

Block 618 represents use in various other programs and/or by various other entities, whether or not through or in cooperation with a universal loyalty program, etc., such as, for example, as described further herein, use in forming or enhancing an encyclopedia of Products, government use, such as in taxation, rebates, research, etc.

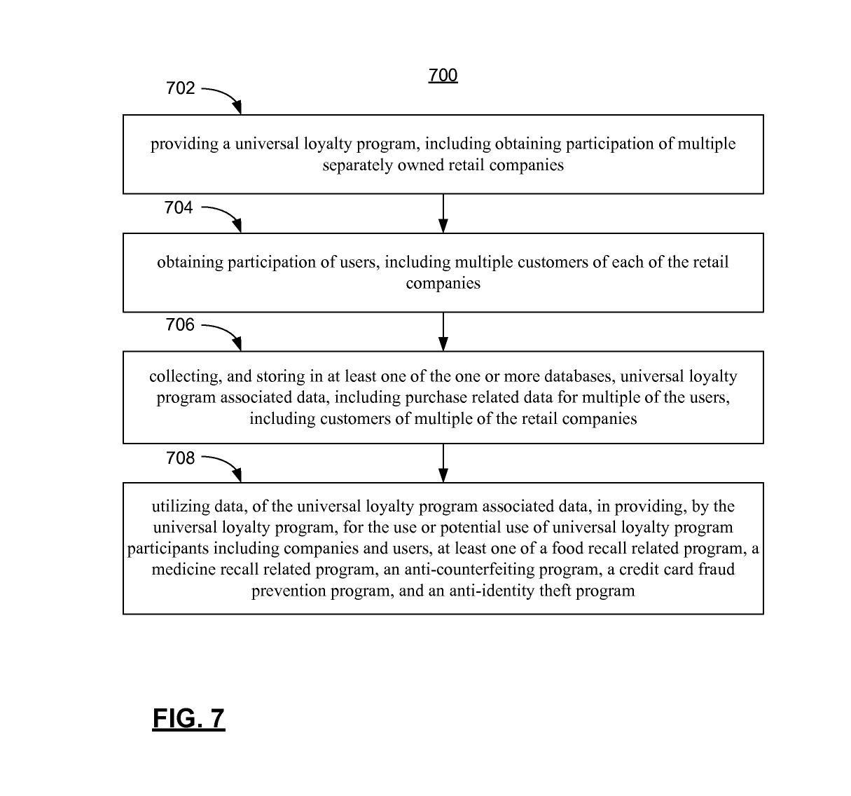

FIG. 7 is a flow diagram illustrating a method 700 according to one embodiment of the invention. Each of the steps of FIGS. 7-11 may be part of or associated with providing a program or providing a universal loyalty program. Block 702 includes providing a universal loyalty program, including obtaining participation of multiple separately owned retail companies.

Block 704 includes obtaining participation of users, including multiple customers of each of the retail companies.

Block 706 includes collecting, and storing in at least one of the one or more databases, universal loyalty program associated data, including purchase related data for multiple of the users, including customers of multiple of the retail companies.

Block 708 includes utilizing data, of the universal loyalty program associated data, in providing, by the universal loyalty program, for the use or potential use of universal loyalty program participants including companies and users, at least one of a food recall related program, a medicine recall related program, an anti-counterfeiting program, a credit card fraud prevention program, and an anti-identity theft program.

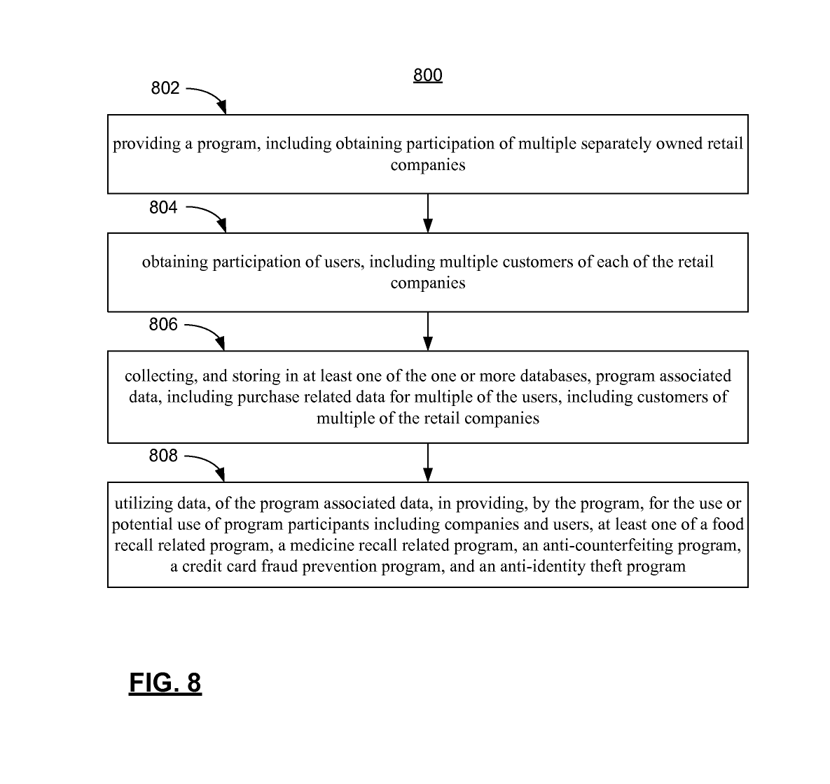

FIG. 8 is a flow diagram illustrating a method 800 according to one embodiment of the invention. Block 802 includes providing a program, including obtaining participation of multiple separately owned retail companies.

Block 804 includes obtaining participation of users, including multiple customers of each of the retail companies.

Block 806 includes collecting, and storing in at least one of the one or more databases, program associated data, including purchase related data for multiple of the users, including customers of multiple of the retail companies.

Block 808 includes utilizing data, of the program associated data, in providing, by the program, for the use or potential use of program participants including companies and users, at least one of a food recall related program, a medicine recall related program, an anti-counterfeiting program, a credit card fraud prevention program, and an anti-identity theft program.

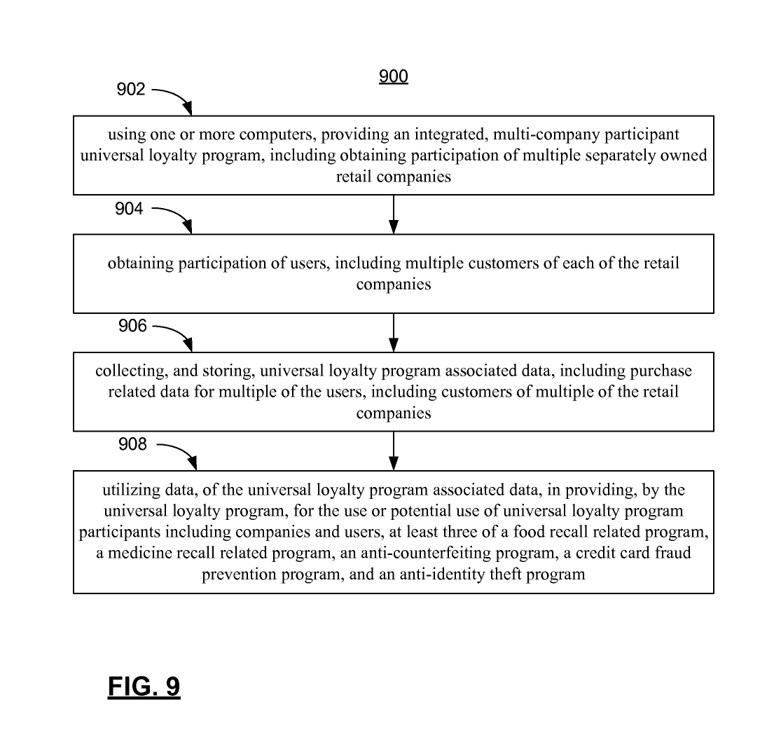

FIG. 9 is a flow diagram illustrating a method 900 according to one embodiment of the invention. Block 902 includes using one or more computers, providing an integrated, multi-company participant universal loyalty program, including obtaining participation of multiple separately owned retail companies.

Block 904 includes obtaining participation of users, including multiple customers of each of the retail companies.

Block 906 includes collecting, and storing, universal loyalty program associated data, including purchase related data for multiple of the users, including customers of multiple of the retail companies.

Block 908 includes utilizing data, of the universal loyalty program associated data, in providing, by the universal loyalty program, for the use or potential use of universal loyalty program participants including companies and users, at least three of a food recall related program, a medicine recall related program, an anti-counterfeiting program, a credit card fraud prevention program, and an anti-identity theft program.

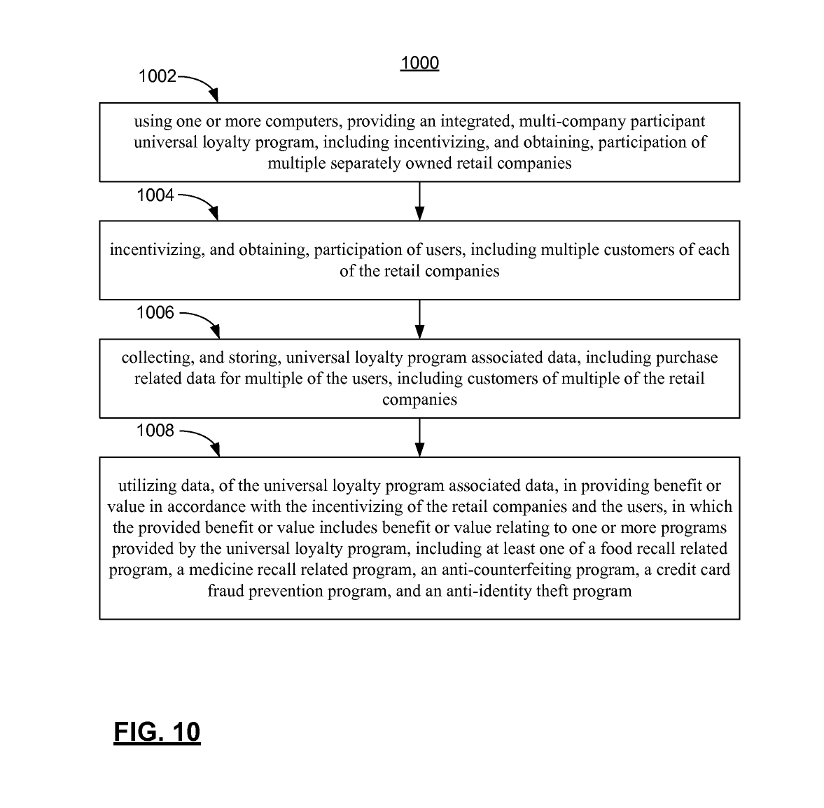

FIG. 10 is a flow diagram illustrating a method 1000 according to one embodiment of the invention. Block 1002 includes, using one or more computers, providing an integrated, multi-company participant universal loyalty program, including incentivizing, and obtaining, participation of multiple separately owned retail companies.

Block 1004 includes incentivizing, and obtaining, participation of users, including multiple customers of each of the retail companies.

Block 1006 includes collecting, and storing, universal loyalty program associated data, including purchase related data for multiple of the users, including customers of multiple of the retail companies.

Block 1008 includes utilizing data, of the universal loyalty program associated data, in providing benefit or value in accordance with the incentivizing of the retail companies and the users, in which the provided benefit or value includes benefit or value relating to one or more programs provided by the universal loyalty program, including at least one of a food recall related program, a medicine recall related program, an anti-counterfeiting program, a credit card fraud prevention program, and an anti-identity theft program.

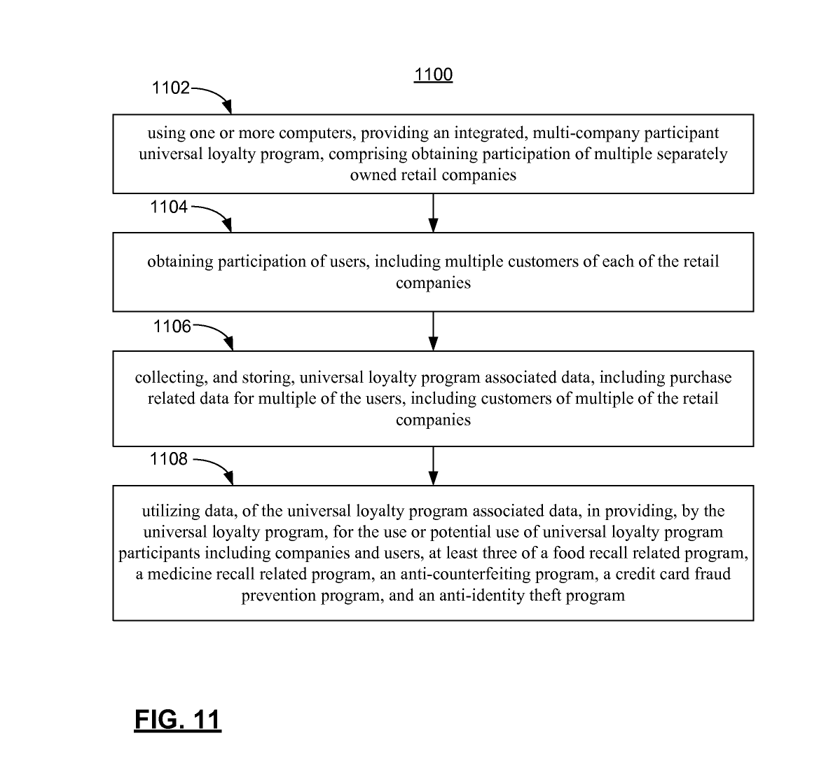

FIG. 11 is a flow diagram illustrating a method 1100 according to one embodiment of the invention. Block 1102 includes using one or more computers, providing an integrated, multi-company participant universal loyalty program, comprising obtaining participation of multiple separately owned retail companies.

Block 1104 includes obtaining participation of users, including multiple customers of each of the retail companies.

Block 1106 includes collecting, and storing, universal loyalty program associated data, including purchase related data for multiple of the users, including customers of multiple of the retail companies.

Block 1108 includes utilizing data, of the universal loyalty program associated data, in providing, by the universal loyalty program, for the use or potential use of universal loyalty program participants including companies and users, at least three of a food recall related program, a medicine recall related program, an anti-counterfeiting program, a credit card fraud prevention program, and an anti-identity theft program.

As generally indicated above, asome embodiments of the invention include a universal loyalty program along with one or more other programs. It is to be understood that embodiments are contemplated that include every possible combination of other programs, whether it be, for example, one, two, three, four or five other programs, or more. For example, some embodiments may include other programs that include one other program, such as a food recall related program, or a medical recall related program only, or an anti-counterfeiting program, or a credit card fraud prevention program, or an anti-identity theft program. Some embodiments may include other programs that include two other programs such as a food recall related program and a medicine recall related program, or a food recall related program and an anticounterfeiting program, or a food recall related program and a credit card fraud prevention program, or a food recall related program and an anti-identity theft program, or a medicine recall related program and an anti-counterfeiting program, and on and on. Similarly for other embodiments that may include three or more other programs, every possibly combination is specifically contemplated. Furthermore, some embodiments may not include a universal loyalty program.

Some embodiments of the invention relate generally systems and methods utilizing ARTAS. More specifically, ARTAS may construct well-known traditional and mobile websites as part of its infrastructure, assign a system unique number or code (SUN) to products (optionally down to unit packs), and request companies to import product information in association with SUN into ARTAS. Through ARTAS, customers can obtain product authentication, and product information using SUN and ARTAS's well-known traditional and mobile websites, and can register their purchase into ARTAS in order to get product recall (if necessary), purchase rebates, discounts, and other important product information. Through ARTAS, companies can use SUN and associated product and customer information for the purpose of anti-counterfeiting, product recall, targeted advertisement, product market research, inventory management, and more.

In some embodiments, the system unique number or code (SUN) of ARTAS can be a combination of a product standardized number or code (PSN, as defined below) and a long unique and random number (CRUNAC, as defined below), or just PSN. PSN can be used to manage, segregate, and group SUN, maintain customer compliance and privacy, manage and enhance database safety, and safe guard confidential data. CRUNAC as a portion of SUN is to make SUN unique, so that SUN can be used to identify products (down to unit packs) for the purpose of anti-counterfeiting, product recall, targeted advertising, product market research, inventory management, and more.

In some embodiments, ARTAS has usefulness in areas such as anti-counterfeiting, product recall, purchase rebates, targeted advertising, product market research, inventory management, etc.

Counterfeiting commercial products, such as drugs, alcohols, electronics, luxury goods, etc, is a very serious global issue. It has caused severe harms to public health and huge profit loss to companies. Anti-counterfeiting has not been very effective so far.

Broadly, there are two main forms of anti-counterfeiting generally in use today are known by vague and often misleading terms of traceability and authentication. Traceability type of anti-counterfeiting is meant to answer the questions “Where has this product come from?” and sometimes called “digital authentication”. Authentication type of anti-counterfeiting is meant to answer the question “Is this product genuine or fake?” and often known as “sensory or physical authentication”. For convenience, physical authentication in the paragraphs below is used to mean “sensory or physical authentication”, in differentiation from “digital authentication”.

There are several variations in the terminology used for traceability or digital authentication systems, such as “serialization”, “pedigree”, and “track and trace”. “Serialization” is the process of assigning a unique number to a unit of product such that it can be identified later. “Pedigree”, on the other hand, is the process of recording most or all of the product history in such a way that the life story of the pack can be reconstructed. “Track and trace” can incorporate either serialization or pedigree or both, and simply implies an ability of the system to know where a product went (track) and where it came from (trace). Track and trace is used in the paragraphs below to represent traceability or digital authentication systems.

“Sensory or physical authentication”, or in short “physical authentication”, relies on many technologies, such as security inks (including color-shifting inks), diffractive optically variable image devices (DOVIDs) and holograms, etc, to help people to differentiate genuine products from fake with or without instruments.

There are limitations to the effectiveness of both physical authentication and track and trace. Physical authentication has to rely on renewing technologies again and again to stay ahead of counterfeiting. No authentication technology can last forever. Applying new authentication technologies increases cost, and sophisticated technologies that cannot be easily counterfeited usually cost substantially more. It also takes resources and time to inform customers the new authentications in order for them to be effective. As a result, physical authentications usually do not change often enough to prevent counterfeiting criminals from developing fake authentications. Another limitation is that there is not any effective way to inform customers the change of authentication. Customers often do not know the change in time before fake authentications show up.

Track and trace systems, once set up, do not necessarily need to be changed. Governments around the world have required or will require certain track and trace systems to be installed for some products, such as drugs. The systems depend on assigning codes to products and recording history of products in association with the codes into databases. Then the history can be traced back with the assistance of websites and databases, and used against counterfeiting by identifying which step in the tracking goes wrong. Track and trace can also be used by customers to authenticate the merchandises they buy. Customers can verify the codes or serial numbers on the merchandises through internet or telephone help lines. Customers have to get on different websites or call different phone numbers to verify different products. There are no centralized websites and telephone help lines for the verification. With so many websites and telephone help lines for authentication, it is or will be confusing to customers, and counterfeiting can take advantage of this situation. Track and trace is not likely to be used as commonly by companies as physical authentication due to cost, especially for medium and small companies. Track and trace systems can also be attacked by counterfeiting criminals. In some of the existing track and trace systems, the codes and serial numbers can be duplicated or mimicked, as can the websites and telephone help lines, because different products require different websites and telephone help lines, and it can be difficult for customers to tell the genuine websites from the fake ones.

Some embodiments of the invention provide a more effective alternative to current authentication systems.

In the interest of public safety, an effective recall system for food products is important in the events of food contamination, bacteria outbreaks, terrorist's attacks, et al. Currently, there is no effective recall system in the events of emergency. We mainly rely on news media to spread the news to alert customers who may be affected. The news may be slow to get to the potentially affected customers, if it can get across at all. An effective recall system has to have a good tracking of most, if not all the food products. A difficulty in establishing an effective recall system through tracking is that the number of unit packs of food products need to be tracked is huge, and the profit margins for most of the producers who would have to apply the traceability information are usually small. Any practical solution must therefore be very cheap. So far, a single technology has not emerged to address these issues.

Some embodiments of the invention provide a novel and effective recall system.

Information regarding their customers is very valuable to companies. Currently, companies do not have effective way to collect this information. Customers buy their products from different stores, even for the same products, so it is hard for companies to know who, when, where and how much (many) regarding a customer's purchase (individual and overall).

Stores are collecting customer purchase information through encouraging customers using their store membership cards or store credit cards (e.g. from individual store loyalty programs). These cards allow stores to recognize their customers at the point of purchase. However, the popularity of these cards may not be high. Customers may not allow stores to share the information with other companies, such as the product manufacturers.

Credit card companies know to a degree where customers go shopping, but they may not know in detail what customers buy. Since customers often have more than one credit card, the whole picture of customers' shopping habits is hard to find out. Many customers do not want credit card companies to distribute their information to other companies, because they want to protect their privacy and it is hard for them to know where and how the information is distributed even if they are willing to share some. Customers can not choose to share a part of their information. If they can choose, it is likely many customers are willing to share a portion of the information, especially when they can get benefits from sharing, because some products are not privacy sensitive. Methods for collecting customer data have included things such as surveys, online orders, prize competitions, market research, etc. There are limitations to all these methods.

Some embodiments of the invention provide a novel and effective system and method to collect customers' information regarding their purchase, if customers allow the information collection. With this information, companies can do product recall, purchase rebate, targeted advertisement, product market research, inventory management, and more.

Some embodiments of the invention is a multi-function system and method (ARTAS) for the purposes of anti-counterfeiting, product recall, purchase rebate, targeted advertisement, product market research, inventory management, and more. The system and method may be termed ARTAS (Authentication, Recall, Target Advertisement, and more System). More specifically, ARTAS may construct an infrastructure (including well-known traditional and mobile websites, desktop fat clients, mobile applications, web services, etc.), assign a system unique number or code (SUN) to products (optionally down to individual packs), and request companies to import product information in association with SUN into ARTAS. Through ARTAS, customers can obtain product authentication, and product information using SUN and ARTAS's well-known traditional and mobile websites, and can register their purchase into ARTAS in order to get product recall (if necessary), purchase rebates, discounts, and other important product information. Through ARTAS, companies can use SUN and associated product and customer information for the purpose of anti-counterfeiting, product recall, purchase rebate, targeted advertisement, product market research, inventory management, and more. Through ARTAS, governments can more effectively collect taxes and distribute rebates, and more importantly, reduce risks to public health, because ARTAS can decrease fake drugs, food, toys, et al, and can quickly and accurately alert affected customers and recall potentially affect products in the events of food and/or medicine contamination, bacteria outbreaks in foods, and terrorist's attacks on food supplies. Through ARTAS, stores can use SUN and associated product and customer information for the purpose of purchase discounts, targeted advertisement, market research, inventory management, etc.

Even though much of the description herein specifically mentions tangible products (goods), some embodiments of the invention can be extended to, among other things, intangible items or services, including but not limited to services and billable entities (fees, warranties, etc.).

The following are some abbreviations and non-limiting definitions of some terms used herein.

ARTAS: Authentication, Recall, Target Advertisement, and more System

SUN: system unique number or code

USUN: Unique SUN, a combination of PSN and CRUNAC

SSUN: Standard SUN, just PSN, without CRUNAC

CRUNAC: completely random and unique numbers or alphanumerical codes

PSN: product standardized number or code

PCA: periodically changed authentication

UA: unique authentication

TLSL: two-layer security label with SUN printed on the top layer and password and/or other verification printed on the hidden bottom layer; USUN is preferred to be on TLSL; PCA or UA can be optionally printed next to SUN or password

OLL: one-layer label with SUN printed

OLL+SSUN: one-layer label with SSUN printed; PCA can be optionally printed next to SUN

OLL+USUN: one-layer label with USUN printed; PCA or UA can be optionally printed next to SUN

Additional abbreviations above are defined or described in the next section, as necessary.

The term “well-known traditional and mobile websites”, as used herein, includes the accesses to the web servers of ARTAS, including traditional and mobile the websites,

The term “product(s)” can include, for example, goods or merchandise, among other things.

In some embodiments, ARTAS assigns system unique number or code (SUN) to products, at the request and assist of companies. If SUN is a combination of a product standardized number or code (PSN) and a long unique and random number (CRUNAC, as defined below), it is called unique SUN (USUN). If SUN is just PSN without CRUNAC, it is called standard SUN (SSUN).

In some embodiments, PSN (product standardized number or code) can operate as follows: product category code+company code+company product code+production batch code+production location code+production date+expiration date+a sequential number. If necessary, additional codes may be added. PSN can be a portion of the codes listed above, such as product category code+company code+company product code, or product category code+company code. Sequence of the code sections in PSN can be rearranged, until it is finalized. For example, product category code can be moved behind company product code. PSN can be compatible with GS1 system standards. In particular, PSN can be compatible with Global Trade Item Number (GTIN), Universal Product Code (UPC), and International Article Code (EAN). For example, the company code and company product code in PSN can be replaced by GTIN, UPC, or EAN, so that PSN is a superset of GTIN, UPC, or EAN. Another way to make PSN a superset of GTIN, UPC, or EAN is inserting GTIN, UPC, or EAN into PSN. If PSN does not have a portion that equals to GTIN, UPC, or EAN, it can be made to correlate to GTIN, UPC, or EAN.

In some embodiments, CRUNAC (completely random and unique numbers or alphanumerical codes) have to be long, such as 10-90 digits for numbers and 5-50 characters for alphanumerical codes, in order to identify any products of any package sizes around the world that need to be tracked and/or authenticated over a long time.

In some embodiments, ARTAS can use a plurality of 2D matrix barcodes (e.g. PDF417, QR Code, Aztec Code, etc.) and radio frequency identification (RFID) technologies for carrying SUN. ARTAS should not be in conflict with any existing or future serialization systems, such as those required or will be required by governments. In some embodiments, the numbers provided by ARTAS can correlate with other serial numbers.

In the near future, it is possible that personal computers and cell phones will widely be equipped with scanners or cameras that can read the 2 D matrix barcodes (e.g. PDF417, QR Code, Aztec Code, etc.) that carry SUN. Therefore, in some embodiments, it may be convenient for customers to scan SUN into ARTAS to obtain authentication and the product information online.

In some embodiments, ARTAS infrastructure can include hardware and software (including, but not limited to, serves, data centers, network, and middleware), equipment, technologies, etc. Secure traditional and mobile websites, desktop fat clients, mobile applications, web services, etc. may be built as part of the infrastructure of ARTAS. These Access points to one or more web servers may be well known to customers worldwide. In some embodiments, ARTAS also can adopt telephone lines in order to provide text messaging services (e.g. SMS), etc.

In some embodiments, the infrastructure enables companies to input product information in association with SUN into ARTAS, and to use SUN and the associated product and customer information for the purpose of anti-counterfeiting, product recall, targeted advertisement, product market research, inventory management, and more. The infrastructure enables customers to obtain product authentication, and product information using SUN and well-known traditional and mobile websites of ARTAS, and to register their purchase into ARTAS in order to get product recall (if necessary), purchase rebates, discounts, and other important product information. The infrastructure enables stores to handle activities related to SUN, such as managing inventory, importing purchase information and customer information (if they permit) into ARTAS.

In some embodiments, ARTAS either provides SUN in forms of labels to companies, or allows companies to print SUN on their products according to the instructions from ARTAS. SUN can be used in a few label forms depending on the purposes and the product profit margin which determines the sensitivity toward cost increase as a result of using ARTAS.

In some embodiments, one form is applying SUN as a two-layer security label (TLSL). The top layer has SUN printed on it. After it is peeled off, a password or other forms of verification is revealed underneath. In the TLSL form, SUN can either be USUN or SSUN, although USUN is preferred. If SSUN is used, PCA (defined below) can be added to increase effectiveness of anti-counterfeiting. If USUN is used, either PCA or UA (defined below) can be added to increase effectiveness of anti-counterfeiting.

Another form is a one-layer label (OLL) with USUN printed (OLL+USUN). In the OLL+USUN form, either PCA or UA can be added to increase effectiveness of anti-counterfeiting.

Still another is a one-layer label (OLL) with SSUN printed (OLL+SSUN). In the OLL+SSUN form, PCA can be added to increase effectiveness of anti-counterfeiting.

In some embodiments, periodically changed authentication (PCA) is done in association with the PSN in SUN. PSN identifies products and product categories. If necessary, ARTAS changes authentications for products or product categories, at the request of companies. The periodical changes can be done according to PSN (including product production date or product expiration date). For example, one kind of Nike shoes that are produced between Jan. 1, 2012 and Jun. 30, 2012 can be labeled with one PCA. Those produced between Jul. 1, 2012 and Dec. 31, 2012 can be labeled a different PCA. Customers can find out PCA on the well-known traditional and mobile websites of ARTAS using PSN. PCA can be more than one authentication. For example, one is changed annually, which can be more sophisticated, and another changed monthly.

In some embodiments, unique authentication is randomly selected and unpredictable authentication(s) in association with USUN. ARTAS can randomly select authentication(s) from many and associate it or them with USUN. UA can be printed on labels next to USUN. Every unit pack can be labeled with a USSN and UA. Customers can verify UA labels by scanning in USUN on the well-known traditional and mobile websites of ARTAS. UA makes it difficult for counterfeiting criminals to steal USUN for fake products, because criminals also have to copy the associated unpredictable UA. UA will at least increase the cost for counterfeiting criminals, if they are capable of copying many different authentication labels. It is also difficult to steal authentication labels, because stealing by taking a picture of UA labels is not likely to capture all the details of the authentication labels. ARTAS can deny disclosing UA online until products are checked out from stores.

One embodiment of an ARTAS infrastructure, or a portion thereof, is depicted in FIG. 1B. In some embodiments, ARTAS infrastructure can be built based in part on what can be learnt from existing track and trace systems, such as those used by UPS and FedEx, mPedigree (by HP), Sproxil, PharmaSecure, CertiLogo, and MobiLUX, etc.

In some embodiments, SUN and the associated product and customer information can be segregated and managed using the PSN portion in SUN. SUN and the associated information can be grouped according to products, product categories, or companies; and the grouped or segregated SUN and its information can be stored and managed to achieve sufficient data security (confidentiality, availability and integrity). All necessary security technologies can be adopted to make ARTAS and its data as secure as possible. The security technologies that can be used include tiered architecture with fire walls, SSL/TLS, data encryption and signing, access controls, etc.

In some embodiments, for the purpose of track and trace anti-counterfeiting, ARTAS can use SUN in a few forms, depending the product profit margin.

In some embodiments, if a product's profit margin is big and counterfeiting risk is high, it is suitable that SUN is applied to the product in the form of the two-layer security label (TLSL), which has SUN printed on its top layer and a password or other forms of verification printed on the bottom layer. The bottom layer is hidden until the top layer is peeled off. SUN is preferred to be USUN. The TLSL can be used in association with PCA or UA (see next section). After purchase, customers can use ARTAS's well-known traditional and mobile websites and/or the telephone lines, scan in the SUN (on the top layer) that associate with the purchased products. Then in response, ARTAS asks the password or other verifications on the bottom layer. The customers can peel off the top layer and enter the password or other verifications. After receiving the password or other verifications, ARTAS sends product related authentication and other information to the customers. The information can be related to product recall, product safety, purchase rebate, discount for the next purchase, targeted advertisements, etc.

In some embodiments, ARTAS can allow customers to do detailed registration for products with TLSL, such as with purchase proof. The detailed registration will allow ARTAS to make an association between the customers and the products. This association may be useful especially for durable luxury goods, which may be resold by customers later. This association can help verifying or authenticating the products in the resell.

In some embodiments, because the product's profit margin is big and counterfeiting risk is high, the exposed SUN may be stolen and put on counterfeiting products. This is a reason of using TLSL. With this form, the stolen SUN is ineffective, because the hidden password or other verifications prevents ARTAS to respond to the stolen SUN. The TLSL should be tamper resistant to prevent the hidden password or other verifications from being stolen without noticing. The cost of TLSL is generally higher, compared to other label forms of SUN. In addition, TLSL also makes return of purchased products more costly, if TLSL is peeled, because a new TLSL has to be put on the returned product to enable the next customer to authenticate his or her purchase. A new TLSL has to be put on by trusted persons. This means the returned product may have to be shipped to a trusted place for relabeling. All these steps increase cost for the product and this is why TLSL is generally more suitable for products of high profit margin and high risk for counterfeiting.

In some embodiments, TLSL may also be suitable for products sold online, because the trustworthiness of websites that sell products is difficult to verify, and thus counterfeiting products sold online are common. The anti-counterfeiting effectiveness of TLSL may be ideal for this situation. In addition, the return of products is not an issue for the purchase online, because returned products have to be shipped anyway. So the shipping can be arranged to a trusted place for verification of the returned goods and rebelling of new TLSL.

If profit margin of a product is marginal and its counterfeiting risk is medium, it may not be necessary to use TLSL, and the cost associated with TLSL may deter companies from choosing it. In this situation, companies may choose one-layer label (OLL) without hidden password to apply USUN, or print USUN directly on their products, if their products have secured supply chains and are sold in trusted stores. Secured supply chains and trusted stores can largely prevent the exposed USUN from stolen, and ARTAS can send information regarding which trusted stores the products should be sold (and optionally when they are sold), when customers verify their purchase through ARTAS. Even if USUN is stolen from the products, the counterfeiting products can be identified, if they are not sold in the designated stores. OLL+USUN can be used in association with PCA or UA to increase effectiveness of anti-counterfeiting (see next section). OLL makes it easier to handle returned products from customers. It is not necessary to apply new OLL. Once a returned product is checked and verified to be authentic, the product can be put back on shelf quickly.

Secured supply chains and trusted stores are common in the developed countries. In the developing countries, it may still be necessary to use TLSL or OLL+USUN in association with UA (see next section) if secured supply chains and trusted stores are not set up. Customers may be charged for returning products if TLSL is peeled off If profit margin of a product is low and its counterfeiting risk is low, the product can still use OLL+SSUN, probably for purposes not related with anti-counterfeiting, but for product recall, purchase rebate, targeted advertisements, product market research, inventory management, and more.

In some embodiments, track and trace using ARTAS can avoid limitations of current track and trace authentication systems. ARTAS can have well-known traditional and mobile websites, fat clients, mobile webs, mobile applications, telephone lines (preferably one each) for customers to authenticate their products, it will be convenient for the customers to remember, and also difficult for criminals to fake or mimic the websites, phone numbers, etc.

In some embodiments, track and trace of ARTAS in its simple form only requires recording product information at manufacturing sites (and at retail stores if the stores are trustworthy), in order to reduce cost. Tracking and tracing products multiple times through their supply chains to obtain fuller pedigree or e-pedigree is optional in ARTAS.

In some embodiments, in addition to track and trace, physical authentication is the other category of anti-counterfeiting. ARTAS provides physical authentication in the forms of PCA and UA. Combining track and trace with PCA or UA further increases anti-counterfeiting effectiveness.

Before explaining how some embodiments combine ARTAS's track and trace with ARTAS's physical authentication, it is important to understand the limitations of current physical authentication. One limitation is that they do not change often enough to prevent counterfeiting criminals from developing fake authentications. Another limitation is that there is not any effective way to inform customers the change of authentication. Customers often do not know the change in time before fake authentications show up. It is costly and difficult to change authentications effectively, especially for small and medium size companies. It is not easy to develop new and effective authentications that are cost efficient. In some embodiments, ARTAS can avoid these limitations.

In some embodiments, ARTAS can provide periodically changed authentication (PCA) and unique authentication (UA). ARTAS can set up one centralized place for authentication, so it is cost efficient for ARTAS to adopt many kinds and many variations of authentications. ARTAS changes authentications periodically for PCA and randomly for UA, so counterfeiting criminals will have to change their fake authentications accordingly to keep up. Even if counterfeiting criminals can keep up, their cost increases substantially, which should curtail counterfeiting significantly. ARTAS may have well-known traditional and mobile websites, so it will be convenient to inform customers and for the customers to follow the changes of authentications, and also difficult for criminals to fake or mimic the websites.

In some embodiments, combining SSUN with PCA can be simple and effective. SSUN can be around relatively short and can be even shorter if alphanumeric codes are used, if only a few code sections are used, such as product category code+company code+company product code+production date (or expiration date). Therefore, SSUN can be scanned in as linear bar codes, and it is also easy to type in the SSUN. PCA can be printed on OLL labels next to SSUN. After purchase, customers can get on the well-known traditional and mobile websites of ARTAS and scan or type in SSUN in order to compare the PCA revealed on the websites and the one on the products. Alternatively, customers can find out PCA before their purchase. Customers can find out PCA of the products they plan to buy from the well-known traditional and mobile websites of ARTAS based on product categories, brand names, and production (or expiration) dates, etc.

In some embodiments, in other label forms of SUN (on TLSL or OLL+USUN), PCA also can be printed on the labels together with SUN. Customers can use PCA the same way as described above, before and after their purchase.

In some embodiments, labels with UA may be more costly to produce than those with PCA, they should be more effective for anti-counterfeiting. PCA changes periodically, counterfeiting criminals have a period time to copy the authentication labels before they change. UA changes randomly and unpredictably, so it is hard to copy.

In some embodiments, UA can achieve very effective anti-counterfeiting even with OLL+USUN. In this case, UA is printed on OLL next to USUN. UA changes randomly for every label, so every label has an unpredictable UA. After purchase, customers can get on the well-known traditional and mobile websites of ARTAS and scan in the USUN on OLL of their purchased products. ARTAS will tell customers the designated UA that is associated with the entered USUN, and how many times this USUN have been verified and when. If counterfeiting criminals only steal and copy one set of USUN and UA, the fake products with this one set of USUN and UA will generate many verification requests in ARTAS. A big number of verification generated by any USUN will alert customers and ARTAS of potential fake products. Therefore, counterfeiting criminals have to steal and copy many sets of USUN and UA to make fake products. UA can be difficult to be stolen in quantity, because taking a picture of UA is not likely to capture all the details of UA, which may show 3D images and/or different appearances from different angles of view. ARTAS can also prevent stealing UA ahead of purchase transaction through websites, because ARTAS can deny disclosing UA until it receives confirmation of purchase transaction. UA can also associate with TLSL.

In some embodiments, it is possible that counterfeiting criminals will try to make their fake products look very similar to the corresponding genuine products, and get SUN for their fake products from ARTAS in order to allow customers to get verification after they buy the fake products. In order to discourage this kind activity, ARTAS can require and check the legitimacy of the companies that want to participate in ARTAS, and ARTAS can search for similarity among products in the same category and let authority to investigate the suspicious products. ARTAS can also alert customers to watch out for the similar products in the same category, especially for products in risk of being counterfeited.

Customers want to safe guard their private information, because they do not want the information distributed to wrong places and used improperly. If they can choose which portion of their information to share and know their information can be safe guarded, and only distributed under their consent and to places for proper use, they may be likely to agree on sharing part of their information (possibly including private information to a degree).

In some embodiments, ARTAS can guarantee customers to safe guard their information (data), only distribute under their consent and directions, and ensure the proper use of the data. ARTAS has the ability to collect customer purchase information (data), if customers agree to register their purchase. Registering purchase means customers allow them to be identified for their purchase by ARTAS and allow their ID to be associated with the products they buy. Registering can be done at stores at the point of sale, when customers allow identification using credit cards, debit cards, etc. Alternatively, registering can be done online at home or anywhere by customers. Customers can tell ARTAS how, to where, and to what extent they want to share their purchase information. For example, they can allow sharing the information only to the companies that produce the products and/or the stores that sell the products, and they can select the products and/or product categories for information sharing. ARTAS has the ability to do what customer want about the information sharing. PSN (part of SUN) can be used for this purpose, because it can identify and segregate the information, based on companies, products, product categories, etc. ARTAS can use PSN to manage, store, secure, and distribute the information.

In some embodiments, in addition to anti-counterfeiting, ARTAS can be used for product recall. To do product recall and more, ARTAS may need customers to register their purchase and provide their contact information. Obviously, customers can choose whether they want to register their purchase and/or provide their contact information. For the products that are not privacy sensitive, it is likely customers are willing to register their purchase and provide their contact information, especially when there are benefits for doing that, such as discount for the next purchases. Because SUN has a component of PSN, ARTAS can allow customers to select in advance which products or which category of products they are willing to register. Customers can also decide to what extent they are willing to share the information.

In some embodiments, based on customer's choices, ARTAS can allow automatic registration, even at the point of purchase when credit cards or debit cards are used to allow ARTAS to identify the customers, or customers can scan in ID. Trusted stores can be connected into ARTAS, so that the information of transactions in the stores can enter ARTAS quickly.

Alternatively, in some embodiments, customers can bring their purchase home and register them by scanning in SUN. In their personal computers, customers can use software provided by ARTAS, pre-select the products or categories of products they are willing to register, so registration can be done very conveniently by just scanning SUN and doing some typing.

For the products that may have safety concerns, such as food and drugs, customers should have greater willingness to register their purchase and/or provide their contact information.

In some embodiments, ARTAS can associate the product information with customers after customer registrations, because even SSUN can carry substantial product information (such as batch number, production date, etc.). In the emergency events, such as food and/or medicine contamination, bacteria outbreaks in food products, and terrorist's attacks on food supplies, ARTAS can quickly inform the potentially affected customers to deal with their purchase properly. The information of transactions (when and where) also can be revealed as additional information for product verification/authentication, when customers check products on the well-known traditional and mobile websites of ARTAS.

In some embodiments, in food industry, profit margin for many food products is low, so cost has to be considered when applying ARTAS to these products, in order to do product recall and more when necessary. For these low profit margin products, participating in ARTAS can be low cost. ARTAS can provide OLL+SSUN for companies to stick the labels on their products. Companies likely do not need to buy additional machines, because many companies already have label applying machines in their packaging lines. Alternatively, companies can print SSUN on their products according to the instructions from ARTAS. Since SSUN is standard, it can be printed like barcodes, which is easy, common and low cost.

In some embodiments, companies can conveniently input product information into ARTAS, including product categories and names, batch numbers, production date, expiration date etc., because SSUN can be grouped using batch numbers, and information about each batch can be imported into ARTAS as same at once. SSUN can carry standard product information, such as batch number, production date, expiration date, etc. Therefore, companies actually do not have to input product information into ARTAS, if standard product information is sufficient, and no additional information is needed for customers to know.

In some embodiments, the simplest and most cost efficient way that companies can use ARTAS is labeling their products with OLL+SSUN or printing SSUN on their products; and this is enough to enable product recall and other uses through ARTAS, after customer registrations.

In some embodiments, the effective recall system can also be used for products beyond food and for purposes in addition to public safety.

In some embodiments, in addition to anti-counterfeiting and product recall as described above, ARTAS provide many other uses to companies, customers and governments, such as targeted advertisements and advertising, purchase rebates and discounts, product market research, inventory management, etc. These benefits are made possible through collection of product information (optionally down to individual pack level) and customer information in association with SUN by ARTAS. It can be easy and low cost for companies to use ARTAS, as described in the previous section. ARTAS can segregate the collected information to safe guard confidential data. For example, ARTAS can separate and safe guard the information belongs to different companies/stores. ARTAS also can separate and safe guard customer information according to their desires and by law.

Over time, ARTAS may accumulate vast information about customers and their purchasing and purchases.

In some embodiments, with this information, companies can do many things, and many to the benefit of customers. For example, building brand loyalty: companies can provide discounts for next purchase to customers after they register their purchase, in order to build brand loyalty. These discounts can be very convenient for customers, because they can be automatic in the next purchase without coupons. ARTAS allow companies to recognize the customers at point of sale and deliver the discounts. Also, targeted advertising: companies can also recommend or advertise products or services to targeted customers, based on the information collected through ARTAS about the customers. Also, Market research: ARTAS can collect vast amount of data connecting product information and customer information through SUN. These data enable companies to do a lot useful product market research, such as accurately identifying customer characteristics for their products and guiding their future product development. Also, accurate purchase rebate: the accurate association of product purchase and customers through SUN can enable accurate purchase rebate. Also, more efficient inventory management: companies can know quickly how many and where of their products are sold, especially when the transactions in stores are linked into ARTAS.

In some embodiments, governments can use ARTAS to assist in collecting taxes from companies and deter tax evasion, because ARTAS can collect data about sales and prices. Social safety net, medical insurance, and other programs run by governments also need to do business, so they also can use ARTAS in many ways, such as ensuring proper use of food stamps, distributing rebates, etc.

In some embodiments, using ARTAS, stores can also get their customer information, so that they can do market research. For example, they can know what products certain customers have a habit of buying, so that they can do targeted and focused sale promotion. The customer information gathered using ARTAS should be more than that collected using store membership cards or store credit cards (e.g. from individual loyalty programs), because the popularity of ARTAS is likely to be much bigger than any store membership cards or store credit cards. In these embodiments, the customer data collection (mining) can be done using ARTAS universal loyalty programs and systems (ARTAS ULP) (see next section).

In some embodiments, if USUN is used, stores can manage their inventories at unit pack level. If SSUN is used, it still carries more detailed information than that at item level (SKU level), which is the information in Universal Product Code (UPC) and International (European) Article Number (EAN). For example, SSUN can differentiate batches, production date, expiration date, production locations, etc. within each item. Therefore, using SUN (USUN or SSUN) can allow more detailed inventory management than using UPC and EAN.

In some embodiments, transition from UPC and EAN based inventory management to SUN based can be straightforward, because PSN (a portion of SUN) can be compatible with UPC and EAN. The transition can be made with a couple changes: 1) scanner (2D barcode) at point of purchase, 2) upgrade of software to convert SUN barcode to the equivalent number in UPC or EAN barcode for store inventory database.

In some embodiments, ARTAS can build online Encyclopedia of Merchandise using its vast product information. More information can be put in the encyclopedia in addition to the information entered for track and trace, product recall, etc. The information may include merchandise's description, history, instructions, ingredients, repair and services, etc. Website links can be provided under merchandise to provide customers additional information and services. Customers can search merchandise in the encyclopedia using product names or scan of barcodes.

In some embodiments, ARTAS can build secure web pages for customers, in order to let them access their own data in ARTAS, so that they can view and manage their purchase, get product information, recalls, rebates, or discounts, and manage personal budgets. On the secure web pages, other uses and applications can be added for customers.

Some embodiments of the invention provide systems and methods that allow track and trace using SUN, down to unit pack using USUN. This track and trace can be used alone for anti-counterfeiting, and in combination with PCA or UA for more effective anti-counterfeiting. This track and trace can also be used for product recall, after customer registration. ARTAS allows product recall to be done very quickly and accurately, which is valuable in emergency. ARTAS also allows product recall to be done at low cost to companies. ARATS can accurately collect, distribute, and use customer purchase data under their consent and directions. ARTAS can collect product and customer information and use SUN to associate the information of purchased products with the information of customers who bought the products. This information and the association can be used for targeted advertisements, purchase rebates and discounts, product market research, inventory management, etc. ARTAS can enable stores to manage their inventories more effectively. ARTAS can build online Encyclopedia of Merchandise. ARTAS can provide secure web pages for customers to manage purchase related activities and more.

One form of customer purchase data mining is related to use of shopping cards (e.g. traditional loyalty programs, see next section for more explanation). Stores issue shopping cards to customers. When customers purchase products and use their shopping cards, their purchase data can be linked to the customers in the database of the stores, because their shopping cards can identify them. However, participation of customers for getting shopping cards may generally be low. The customer data is collected and separated in different databases of stores, so full data about any customer may not be generated. These separated databases may be difficult to combine, because there may be no good way to connect customer data in the different databases.

In some embodiments, ARTAS can perform customer data mining. It issues universal customer identifications (CID, see next section for more explanation) to customers for them to identify themselves at the point of purchase at any store, so that their purchase data can be linked to their CID and collected. Incentives are given to customers, so that they are willing to use CID in different stores. The incentives include services of anti-counterfeiting, anti-identity-theft (prevent misuse of credit cards), purchase discount, product information, customer service platforms, etc. Because CID is used in different stores, the customer data collected is from different stores and thus may be more complete than data collected by using shopping cards specific to individual stores. In these embodiments, the customer data mining can be done using ARTAS universal loyalty programs and systems (ARTAS ULP) (see next section).

In some embodiments, in order for ARTAS customer data mining (using CID) to work or work most effectively, stores may have to participate in ARTAS (and stop their shopping card programs). Since the customer data generated from their shopping card programs are valuable, the stores may not be likely to stop them without financial incentives. Since the customer data mining of ARTAS may be much more powerful and complete, its data may be more valuable. ARTAS can share the profit from its customer data mining with stores, so that they are willing to participate in ARTAS and give up their shopping card programs. It is logical for stores to participate in ARTAS and benefit from ARTAS profit sharing, because their shopping card programs do not compete well with ARTAS for customer data mining (using CID).

In some embodiments, there are other ways that may be used to convince stores to participate in ARTAS. Governments are interested in stopping counterfeiting and setting up a system for effective drug/food recall in emergency situations. ARTAS may be able to help governments to achieve these goals, so it may be likely governments will help ARTAS and require stores to participate. Participation of stores may be important for ARTAS to work toward achieving government's goals for anti-counterfeiting and food/drug recall. Another way to convince stores to participate may be to apply pressure from credit card companies and their associated banks ARTAS may offer a service of preventing or curtailing unauthorized credit card use, and this service may be beneficial to credit card companies and their associated banks, because credit card companies and their associated banks may have to pay for the financial loss incurred from unauthorized credit card use, if unauthorized credit card use is not stopped or reduced. It is logical for credit card companies and their associated banks to support ARTAS for this service and apply pressure on stores to corporate with ARTAS if necessary. For example, if stores do not corporate, the financial loss of credit card misuse may be transferred to them. Food companies may apply pressure on grocery stores for them to participate in ARTAS, if they do not voluntarily do so, because food companies likely will suffer financial loss, if effective food recall system of ARTAS is not set up. Top brand name companies (e.g. Nike) may also apply pressure on stores (e.g. sporting goods stores) for them to participate in ARTAS for the anti-counterfeiting services ARTAS provides. Customers may demand stores to join ARTAS for the convenience and services they may get from ARTAS.

In some embodiments, once stores participate in ARTAS and accept CID at purchase, stores can make ARTAS more effective in its services of anti-counterfeiting, anti-identity-theft, food/drug recall, customer data mining, etc. Stores can authenticate and register their relevant inventories in ARTAS. After their registration (USUN, date, locations, store names, etc.), ARTAS can provide information to customers when they identify themselves using CID at purchase. The information can be used for anti-counterfeiting. If a product identified by USUN is not sold at right store within right time frame, it is likely the product is fake or mishandled, and involved customers can be notified, because the involved customers are identified by CID and the purchase is registered in ARTAS at the point of purchase.

In some embodiments, customers can authorize their credit cards or other payment methods to be used only with the CID they choose. When customers identify themselves using CID at purchase and CID is associated with credit cards or other payment methods, ARTAS, stores and customers can find out whether the payment methods (e.g. credit cards) are matched with correct CID. A mismatch means unauthorized use.

In some embodiments, when customers identify themselves using CID at purchase, CID and associated purchase information is collected by ARTAS. If food, drug, or other products needs to be recalled, ARTAS can immediately identify the affected customers using USUN of the recall items and CID, notify the customers through emails, phone calls, text messages, etc., which are the selected communication by customers and associated with their CID.

In some embodiments, participation of stores in ARTAS and use of CID at purchase to identify customers is important to ARTAS for its services in customer data mining, anti-counterfeiting, anti-identity-theft, food/drug recall, etc. The customer data mining of ARTAS is far superior compared to that of shopping card programs (e.g. traditional loyalty programs).

In some embodiments, ARTAS is a powerful and comprehensive system or method that is capable of achieving global effects in anti-counterfeiting, customer data mining, food/drug recall, etc. In some embodiments, one application of ARTAS is in securing pharmaceutical products.

Fake and substandard medicines are big, growing and serious problem that directly affects patient's safety in the world. For example, as of this writing, the state of California is working on epedigree law that is planned to take effect in January 2015. The new law is being designed to require drugs to be tracked and traced throughout their supply chains in order to secure medicines. The buildup of California system is likely to be very costly. Other activities are taking place for a US federal law related to pharmaceutical epedigree, but California is leading the way. The European Union is working on similar laws or measures to track and trace the medicines in EU markets. The cost to set up the track and trace system in EU is expected to be very high, too. These track and trace systems in discussion will be useful for securing medicines, but the associated cost may delay the implementation and limit the scope of utility.

In some embodiments, ARTAS can also meet the requirement of securing medicine, when it is applied to pharmaceutical industry and its markets. The initial set up of ARTAS may also be costly, but it is designed to make a profit. Therefore, the support for ARTAS is likely greater than other systems, and its implementation may be faster.

Identity theft is a serious problem in the world and it is growing bigger. One type of identity theft is stealing credit/debit card information and making unauthorized purchases or money withdrawal, which results in financial loss to credit/debit card holders, card issuers, banks and stores. In some embodiments, CID can be utilized in fighting identity theft and credit card fraud.

In some embodiments of the invention, CID can be divided into a standard portion and a random portion. The standard portion can include country number or code, city number or code, etc. The random portion is a random number or code. CID can optionally include other security feature, such as a security token.

In an alternative embodiment, CID can be changed periodically or at the request of customers to prevent customer's identity from being stolen.

In some embodiments, ARTAS can also use CID to manage the data. All necessary security technologies can be adopted to make ARTAS and its data as secure as possible. The security technologies that can be used include tiered architecture with fire walls, SSL/TLS, data encryption and signing, access controls, etc.

One common identity-theft is stealing credit/debit card information and using it to make unauthorized purchases or money withdrawal. In some embodiments, using ARTAS and its CID can effectively decrease this kind of identity-theft.

In some embodiments, if customers use CID to identify themselves at the point of purchase transactions, their CID can associate with their purchases and payment method, such as credit card or debit card. Unauthorized use of their credit cards or debit cards can be identified through verifying CID. Ideally in the future, all purchases will require scanning and verifying CID if credit/debit cards are used. If this requirement is not set up, customers can require their credit/debit cards to be used only in association with CID that they select. If identification through CID can be carried out at the point of purchase, unauthorized purchases can be prevented. If the identification cannot be carried out at the point of purchase, customers can still identify and dispute unauthorized purchases easily simply through checking whether the purchases in their accounts are associated with wrong CID.

In some embodiments, in order to make this anti-identity-theft to work, CID needs to be safe guarded to prevent criminals from stealing both credit/debit card information and CID. CID is encouraged to be carried outside the wallets. Security token and other security measures can be added to CIN to make it more secure. CID can be changed periodically or at the request of customers to prevent customer's identity from being stolen.

In some embodiments, upon customer's consent, ARTAS collects customer's purchase data (e.g. in association with CID and SUN). These data can be converted into many services for customers. ARTAS can build secure customer service platform accessible online to provide services to customers. On the platform, customers can view and manage all their purchases. They can get product and purchase related information, such as instructions, warnings, recalls, authenticity, etc. Companies can deliver purchase discounts, rebates and other information and services through this platform of ARTAS. ARTAS can build tools and services in this platform to help customers to analyze, organize and manage their purchases.

Some embodiments of the invention provide unique anti-counterfeiting labels and other related technologies, which may include what is referred to herein as DPAL (digital and physical authentication labels). DPAL can include, for example, any association of s serial number or code (e.g. SUN) with PCA or UA; in the form of labels, DPAL may be TLSL or OLL in association with PCA or UA. In some embodiments, DPAL can be labels or other forms that carry both a serial number or code, like SUN, and physical authentication that changes in a designed way, like in PCA or UA. Physical authentication, such as holograms, can be changed periodically according to production date or expiration date, which can be a portion in a serial number or code, such as SUN. It can also be changed according to any variation in a serial number or code, such as SUN. It can even be changed randomly if it is associated with a random number, such as USUN. DPAL improve anti-counterfeiting effectiveness by combining track and trace authentication with physical authentication.

In some embodiments, ARTAS can provide many services, such as anti-counterfeiting, product recall, anti-identity-theft, customer service platform, targeted advertisements, purchase discounts and rebates, market research, inventory management, etc. as well as anti-counterfeiting, product recall, anti-identity-theft and customer service platforms. ARTAS anti-counterfeiting services can uniquely combine track and trace authentication with physical authentication, in the form of DPAL. Therefore, it is very effective. In addition, the service is flexible. Depending on anti-counterfeiting needs, it can be simple and low cost, and it can be sophisticated and very effective. ARTAS product recall is also unique, because it can quickly inform customers in the events of emergency, such as food or drug contamination. ARTAS anti-identity-theft service can prevent or greatly decrease unauthorized use of credit/debit cards. An ARTAS customer platform provides comprehensive and special services related to purchase.

In some embodiments, ARTAS combines these services to make these services much more effective. Because ARTAS provides multiple services, it gives customers many benefits after they join. ARTAS also requires minimum to no change of customer behavior for them to participate. Combination of the services can result in much bigger customer participation. It also gives companies and governments multiple benefits and can generate bigger support from them. Big participation and support produces services with great effectiveness.

In some embodiments, big customer and company participation and support from governments makes ARTAS anti-counterfeiting service to have unprecedented effectiveness. Bigger customer participation identifies more fake products and results in more investigation, earlier detection, and smaller damage. Bigger company participation and the flexibility of ARTAS services allow more products protected by ARTAS anti-counterfeiting service. With ARTAS, small and medium companies can afford effective anti-counterfeiting services. Big participation can enable a big portion of products labeling with SUN. SUN can enable law enforcement easily verify the authenticity of inventories in stores and supply chains. Therefore, more reliable stores and supply chains can be set up. Online stores can also be more easily monitored or verified by law enforcement, once ARTAS is set up. Online stores are notoriously difficult to control and verify for their inventories and many of them sell counterfeiting products. ARTAS has the potential to be set up in many countries around the world, so international cooperation in cracking down counterfeiting may be enhanced by ARTAS (for more than online stores). The inventories of online stores may be verified for authenticity by law enforcement no matter where they are located. Online stores may be required to join ARTAS, so that their transactions can be monitored by ARTAS anti-counterfeiting services in similar ways as the services monitoring for traditional stores.

In some embodiments, big participation is also important for food/drug product recall in emergency. Big customer participation enables quick and direct reach to a big portion of them in emergency. ARTAS can allow low cost to companies to participate, which is important for food industry, because many food producers have low profit margin.

In some embodiments, ARTAS anti-identity-theft service can generate customer participation, because identity theft is serious and affects many customers. It can also bring in participation from credit card companies, banks and stores, because unauthorized credit/debit card use may inflict financial loss to them.

In some embodiments, big customer participation can enable unprecedented effective customer (purchase) data mining. These data can be converted into many effective services, such as those in customer platform. These data also can generate multiple effective services for companies, such as targeted advertisement and product market research.

In some embodiments, therefore, the bigger the participation and support from customers, companies and governments are, the more effective the customer data mining and ARTAS services are. In return, the more effective ARTAS services are, the bigger the participation and support are.

As such, in some embodiments, the present invention provides systems and methods that allows track and trace using SUN, down to unit pack using USUN. This track and trace can be used alone for anti-counterfeiting, and in combination with PCA or UA for more effective anti-counterfeiting. This track and trace can also be used for product recall, after customer registration. ARTAS allows product recall to be done very quickly and accurately, which is valuable in emergency. ARTAS also allows product recall to be done at low cost to companies. ARATS can accurately collect, distribute, and use customer purchase data under their consent and directions using SUN and CID. ARTAS can collect product and customer information and use SUN and CID to associate the information of purchased products with the information of customers who bought the products. This information and the association can be used for anti-identity-theft, targeted advertisements, purchase rebates and discounts, product market research, inventory management, etc. ARTAS can enable stores to manage their inventories more effectively. ARTAS can build online Encyclopedia of Merchandise. ARTAS can build secure customer service platform for customers to manage purchase related activities and more.

In some embodiments, DPAL is provided or utilized, which can be an association of a serial number or code (such as SUN) with physical authentication (such as holograms), which changes according to the variations in the serial number or code. It can be in multiple forms. For example, one form is labels that have both SUN and physical authentication, and another form is SUN printing on product package and physical authentication as labels stick next to SUN. DPAL combines track and trace authentication with physical authentication.

In some embodiments, ARTAS can provide multiple effective services, such as anti-counterfeiting (track and trace using SUN, optionally in combination with PCA or UA), anti-identity-theft (using CID), quick product recall in emergency (can be low cost for companies to participate), and customer platform. In addition, ARTAS can also provide other services, such as targeted advertising, purchase discounts and rebates, product market research, etc. Combinations of these services provide many more benefits to customers and results in greater participation and compliance from customers. The combinations also provide greater benefits to companies and governments, which results in greater support from companies and governments. Greater participation and support makes ARTAS services much more effective.

The following provides some non-limiting and exemplary description of some types of loyalty and other programs and systems, including ARTAS universal loyalty programs and systems (ARTAS ULP). Many, if not all of ARTAS services can be provided through or in connection with ARTAS ULP, so ARTAS ULP can be a way of describing ARTAS.

Some loyalty programs can include, for example, a marketing program designed to enhance brand loyalty by cultivating an ongoing relationship between a marketer and his customer. For example, some types of successful loyalty programs may encourage the consumer to buy frequently, to increase the amount spent each time, and to concentrate all or most of their related purchases on that brand. Some loyalty programs offer perks for membership in a club or program and reward purchases. Rewards may be based on the dollar value of purchases made or on the frequency of purchases. Well-known loyalty programs include airline frequent-flyer programs that may offer discounts against future travel, which may be called award or reward miles. Many large supermarket chains now have frequent-buyer clubs that offer no-coupon discounts as well as newsletters and affiliate discounts. Some loyalty program tactics also include regular communication with customers such as reminder mailings, private credit cards, cross-sell and up-sell offers, satisfaction and opinion surveys, and collection of information for member databases.

Some loyalty programs are structured marketing efforts that reward, and therefore encourage, loyal buying behavior, which behavior is potentially beneficial to the company. In marketing generally, and in retailing more specifically, a loyalty card, rewards card, points card, advantage card, or club card may be a plastic or paper card, visually similar to a credit card or debit card, that identifies the card holder as a member in a loyalty program. Loyalty cards may be a system of the loyalty business model. In the United Kingdom, it is typically called a loyalty card, in Canada a rewards card or a points card, and in the United States either a discount card, a club card or a rewards card. Cards typically have a barcode or magstripe that can be easily scanned, and some are even chip cards. Small keyring cards (also known as keytags) which serve as key fobs are often used for convenience in carrying and ease of access.

With some types of loyalty programs, in addition to using a traditional loyalty card to identify the persons who participate in loyalty programs, other methods can also be used to identify the participants. These methods may use technologies involve mobile phones, near field communication (NFC), radio-frequency identification (RFID), or 2-D barcodes, etc. CID of ARTAS (ULP) can use all of these technologies for customer identification.

Some loyalty programs can identify customers (members of the program) at the point of sales, and collect customer's purchase information (data). The customer data along with customer ID can be stored in the program's database.

In some embodiments of the invention, ARTAS universal loyalty programs are provided that may be accepted by multiple retail businesses with different owners or shareholders, including large retail businesses (i.e., Macy's, Target, Safeway, or American Airlines, etc.). Big retail businesses may prefer to own their own loyalty programs and have reluctance to join universal loyalty programs. The participation of big retail businesses in a universal loyalty program may indicate wide acceptance by businesses. In addition to the traditional benefits of a loyalty program to retailers, some ARTAS universal loyalty programs, according to some embodiments of the invention, provide unique incentives to retail businesses to encourage them to participate. Incentives or benefits may also be provided to non-retail businesses, so they are likely to support the system. The system may provide benefits to governments, so they may be likely to support the system.

Some embodiments of ARTAS ULP provide food recall related systems. In some embodiments, some such systems may, for example, among other things, identify food products that are potentially harmful or substandard when multiple related food induced health issues occur, and help prevent these food products from reaching customers. If these dangerous products have been sold, this system can quickly identify the customers who purchased these products and let them know (through emails, SMS, phone calls, etc.) to get rid of the dangerous products. For example, if a number of customers got a similar sickness after purchasing and consuming certain same food product (e.g. with the same production site, date, and lot, etc.), a recall of this product (at least a portion of it) may be warranted. In this case, ARTAS can facilitate this product to be taken off selves immediately and immediately inform customers who bought this product the proper actions to deal with this recall. This system is capable of informing customers about the dangerous products, even when they bought the products in multiple stores (for example, if the stores participate in this system). This system has the ability to encourage many stores to participate. This system provides cost efficient ways for food industry to participate, because many food producers have low profit margins.

Some embodiments of ARTAS ULP provide medicine recall related systems. For example, some embodiments provide a system that can identify the affected medicines when they do not meet required standards (e.g. production error, substandard ingredients), and help prevent these medicines from reaching patients. If these products have reached hospitals, pharmacies and patients, this system can quickly identify the affected hospitals, pharmacies and patients and let them know to get rid of the dangerous medicines. For example, if a number of patients got unusual but similar symptom after taking certain same medicine (e.g. with the same production site, date, and lot, etc.), a recall of this medicine (at least a portion of it) may be warranted. In this case, ARTAS can prevent this medicine from further reaching patients and immediately inform patients who bought or were prescribed this medicine the proper actions to deal with this recall.

Some embodiments of ARTAS ULP provide anti-counterfeiting systems. For example, some embodiments provide a system that can quickly inform customers (through emails, SMS, phone calls, etc.) if they have purchased counterfeit or suspicious products in stores (including online stores) that participate in this system. This system allows customers to authenticate their purchased products by themselves. This system also enables monitoring or authenticating products throughout supply chains and in stores (by law enforcement or others). This system can combine track and trace technologies with physical authentication methods or technologies, including Periodically Changed Authentication (PCA) and Unique Authentication (UA). This system can provide unique authentication labels, including TLSL, OLL+SSUN+PCA, OLL+USUN+PCA, OLL+USUN+UA.

Some embodiments of ARTAS ULP provide systems relating to anti-identity theft and to credit card fraud prevention. For example, some embodiments provide a system that can inform customers if their credit/debit cards are used by unauthorized persons. This system can also stop the unauthorized use at the point of sale.

While the invention is described with reference to the above drawings, the drawings are intended to be illustrative, and the invention contemplates other embodiments within the spirit of the invention.

1. A system comprising:
one or more server computers coupled to a network; and
one or more databases coupled to the one or more server computers;
wherein the one or more server computers are for:
providing a universal loyalty program, comprising:
obtaining participation of multiple separately owned retail companies;
obtaining participation of users, including multiple customers of each of the retail companies;
collecting, and storing in at least one of the one or more databases, universal loyalty program associated data, including purchase related data for multiple of the users, including customers of multiple of the retail companies; and
utilizing data, of the universal loyalty program associated data, in providing, by the universal loyalty program, for the use or potential use of universal loyalty program participants including companies and users, at least one of a food recall related program, a medicine recall related program, an anti-counterfeiting program, a credit card fraud prevention program, and an anti-identity theft program.

2. The system of claim 1, comprising obtaining participation of multiple separately owned retail companies, including multiple large retail companies, wherein a large retail company is a retail company that had a revenue of greater than five hundred million dollars in the calendar year prior to the year in which the retail company began participation in the universal loyalty program.

3. The system of claim 1, comprising providing a food recall related program.

4. The system of claim 1, comprising providing a medicine recall related program.

5. The system of claim 1, comprising providing an anti-counterfeiting program.

6. The system of claim 1, comprising providing a credit card fraud prevention program.

7. The system of claim 1, comprising providing an anti-identity theft program.

8. The system of claim 1, comprising providing a food recall related program and an anti-counterfeiting program.

9. The system of claim 1, comprising providing a food recall related program a credit card fraud prevention program.

10. The system of claim 1, comprising providing an anti-counterfeiting program and a credit card fraud prevention program.

11. The system of claim 1, comprising providing a food recall related program, an anti-counterfeiting program and a credit card fraud prevention program.

12. The system of claim 1, comprising providing a food recall related program, a medicine recall related program, an anti-counterfeiting program, a credit card fraud prevention program and an anti-identity theft program.

13. The system of claim 1, comprising assigning system unique numbers or codes (SUNs) to products, or groups of products, for use in product tracking by or within the universal loyalty program.

14. The system of claim 1, comprising assigning system unique numbers or codes (SUNs) to products, or groups of products, for use in product tracking by or within the universal loyalty program, and comprising utilizing two-layer security labels (TLSLs) in product labeling, wherein top layers include system unique numbers or codes (SUNs) and bottom layers include passwords or verification information.

15. The system of claim 1, comprising assigning system unique numbers or codes (SUNs) to products, or groups of products, for use in product tracking by or within the universal loyalty program, and comprising utilizing a one-layer security labels (OLL) in product labeling, including system unique numbers or codes (SUNs).

16. The system of claim 1, comprising assigning system unique numbers or codes (SUNs) to products, or groups of products, for use in product tracking by or within the universal loyalty program, and comprising utilizing periodically changed authentication (PCA) in association with system unique numbers or codes (SUNs) in product labeling.

17. The system of claim 1, comprising assigning system unique numbers or codes (SUNs) to products, or groups of products, for use in product tracking by or within the universal loyalty program, and comprising utilizing unique authentication (UA) in association with system unique numbers or codes (SUNs) in product labeling.

18. The system of claim 1, comprising utilizing data, of the universal loyalty program associated data, in providing, by the universal loyalty program, for the use or potential use of universal loyalty program participants including companies and users, a food recall related program, wherein universal loyalty program participant user registration of food products is utilized in facilitating providing food product recall information to universal loyalty program participant users, and wherein the food recall related program includes a capability to provide food recall related messaging to users via email, SMS messaging, or email.

19. The system of claim 1, comprising utilizing data, of the universal loyalty program associated data, in providing, by the universal loyalty program, for the use or potential use of universal loyalty program participants including companies and users, a medicine recall related program, wherein universal loyalty program participant user registration of medicine products is utilized in facilitating providing medicine product recall information to universal loyalty program participant users, wherein the medicine recall related program comprises the capability to provide medicine recall related messaging to users via email, SMS messaging, or email.

20. The system of claim 1, comprising utilizing data, of the universal loyalty program associated data, in providing, by the universal loyalty program, for the use or potential use of universal loyalty program participants including companies and users, an anti-counterfeiting program, wherein universal loyalty program participant user registration of products is utilized in facilitating track and trace methodology based anti-counterfeiting measures, and comprising utilizing digital and physical authentication labels (DPAL) in product labeling.

21. The system of claim 1, comprising utilizing data, of the universal loyalty program associated data, in providing, by the universal loyalty program, for the use or potential use of universal loyalty program participants including companies and users, a credit card fraud prevention program, wherein universal loyalty program participant users are assigned, by and for the universal loyalty program, customer identification (CID), and wherein CIDs are utilized in credit card fraud prevention, and wherein the credit card fraud prevention program comprises a capability to provide credit card fraud prevention related messaging to users via email, SMS messaging, or email.

22. The system of claim 1, comprising utilizing data, of the universal loyalty program associated data, in providing, by the universal loyalty program, for the use or potential use of universal loyalty program participants including companies and users, an anti-identity theft program, wherein universal loyalty program participant users are assigned, by and for the universal loyalty program, customer identification (CID), and wherein CIDs are utilized in anti-identity theft measures, and wherein the anti-identity theft program comprises a capability to provide anti-identity theft related messaging to users via email, SMS messaging, or email.

23. The system of claim 1, comprising utilizing data, of the universal loyalty program associated data, in at least one of marketing research, an encyclopedia of products and government use in relation to taxation, and a customer service platform.

24. The system of claim 1, comprising utilizing data, of the universal loyalty program associated data, in companies providing to users at least one of electronic or online targeted advertisements, coupons, discounts, group discounts, points or rebates.

25. A system comprising:
one or more server computers coupled to a network; and
one or more databases coupled to the one or more server computers;
wherein the one or more server computers are for:
providing a program, comprising:
obtaining participation of multiple separately owned retail companies;
obtaining participation of users, including multiple customers of each of the retail companies;
collecting, and storing in at least one of the one or more databases, program associated data, including purchase related data for multiple of the users, including customers of multiple of the retail companies; and
utilizing data, of the program associated data, in providing, by the program, for the use or potential use of program participants including companies and users, at least one of a food recall related program, a medicine recall related program, an anti-counterfeiting program, a credit card fraud prevention program, and an anti-identity theft program.

26. The system of claim 25, comprising obtaining participation of multiple separately owned retail companies, including multiple large retail companies, wherein a large retail company is a retail company that had a revenue of greater than five hundred million dollars in the calendar year prior to the year in which the retail company began participation in the universal loyalty program.

27. The system of claim 25, comprising utilizing the data in providing a food recall related program.

28. The system of claim 25, comprising utilizing the data in providing a food recall related program and an anti-counterfeiting program.

29. The system of claim 25, comprising utilizing the data in providing a food recall related program and a credit card fraud prevention program.

30. The system of claim 25, comprising utilizing the data in providing an anti-counterfeiting program and a credit card fraud prevention program.

31. The system of claim 25, comprising utilizing the data in providing a food recall related program, an anti-counterfeiting program and a credit card fraud prevention program.

32. A method comprising:
using one or more computers, providing an integrated, multi-company participant universal loyalty program, comprising:
obtaining participation of multiple separately owned retail companies;
obtaining participation of users, including multiple customers of each of the retail companies;
collecting, and storing, universal loyalty program associated data, including purchase related data for multiple of the users, including customers of multiple of the retail companies; and
utilizing data, of the universal loyalty program associated data, in providing, by the universal loyalty program, for the use or potential use of universal loyalty program participants including companies and users, at least one of a food recall related program, a medicine recall related program, an anti-counterfeiting program, a credit card fraud prevention program, and an anti-identity theft program.

33. The method of claim 32, comprising obtaining participation of multiple separately owned retail companies, including multiple large retail companies, wherein a large retail company is a retail company that had a revenue of greater than five hundred million dollars in the calendar year prior to the year in which the retail company began participation in the universal loyalty program.

34. A method comprising:
using one or more computers, providing an integrated, multi-company participant universal loyalty program, comprising:
incentivizing, and obtaining, participation of multiple separately owned retail companies;
incentivizing, and obtaining, participation of users, including multiple customers of each of the retail companies;
collecting, and storing, universal loyalty program associated data, including purchase related data for multiple of the users, including customers of multiple of the retail companies; and
utilizing data, of the universal loyalty program associated data, in providing benefit or value in accordance with the incentivizing of the retail companies and the users,
wherein the provided benefit or value includes benefit or value relating to one or more programs provided by the universal loyalty program, including at least one of a food recall related program, a medicine recall related program, an anti-counterfeiting program, a credit card fraud prevention program, and an anti-identity theft program.

35. The method of claim 34, comprising incentivizing, and obtaining, participation of multiple separately owned retail companies, including multiple large retail companies, wherein a large retail company is a retail company that had a revenue of greater than five hundred million dollars in the calendar year prior to the year in which the retail company began participation in the universal loyalty program.

36. The method of claim 34, comprising utilizing data, of the universal loyalty program associated data, in providing benefit or value in accordance with the incentivizing of the retail companies and the users, wherein the provided benefit or value includes benefit or value relating to programs provided by the universal loyalty program, including a food recall related program, a medicine recall related program, an anti-counterfeiting program, a credit card fraud prevention program, and an anti-identity theft program.

37. A computer readable medium or media containing instructions for executing a method comprising:
using one or more computers, providing an integrated, multi-company participant universal loyalty program, comprising:
obtaining participation of multiple separately owned retail companies;
obtaining participation of users, including multiple customers of each of the retail companies;
collecting, and storing, universal loyalty program associated data, including purchase related data for multiple of the users, including customers of multiple of the retail companies; and
utilizing data, of the universal loyalty program associated data, in providing, by the universal loyalty program, for the use or potential use of universal loyalty program participants including companies and users, a food recall related program, a medicine recall related program, an anti-counterfeiting program, a credit card fraud prevention program, and an anti-identity theft program.
